(19) United States
(12) Patent Application Publication
(10) Pub. No.: US 2024/0063473 A1
(43) Pub. Date: Feb. 22, 2024

(54) TRACTION BATTERY ASSEMBLY HAVING A THERMAL EXCHANGE PLATE WITH A THERMAL BARRIER

(71) Applicant: Ford Global Technologies, LLC, Dearborn, MI (US)

(72) Inventors: Bhaskara Rao Boddakayala, Troy, MI (US); James Lawrence Swoish, Northville, MI (US); Parikshit S. Gupte, West Bloomfield, MI (US); Ravi Saripella, Farmington Hills, MI (US)

(21) Appl. No.: 17/889,822

(22) Filed: Aug. 17, 2022

(51) Int. Cl. H01M 10/658; H01M 50/209; H01M 50/249; H01M 10/625; H01M 10/647; H01M 10/6554

(52) U.S. Cl. CPC H01M 10/658; H01M 50/209; H01M 50/249; H01M 10/625; H01M 10/647; H01M 10/6554; H01M 2220/20

(57) ABSTRACT

A traction battery assembly includes a thermal exchange plate, a battery array disposed on the thermal exchange plate, an enclosure structure supporting the battery array and the thermal exchange plate, and a thermal barrier sandwiched between the thermal exchange plate and the enclosure structure. A method of shielding areas of a traction battery pack from thermal energy includes positioning a thermal barrier between a thermal exchange plate and an enclosure structure. The thermal barrier is configured to block transfer of thermal energy from the thermal exchange plate to the enclosure structure.

### TECHNICAL FIELD

This disclosure relates generally shielding battery arrays from thermal energy and, more particularly, to shielding a lower tier battery array.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

### SUMMARY

In some aspects, the techniques described herein relate to a traction battery assembly, including: a thermal exchange plate; a battery array disposed on the thermal exchange plate; an enclosure structure supporting the battery array and the thermal exchange plate; and a thermal barrier sandwiched between the thermal exchange plate and the enclosure structure.

In some aspects, the techniques described herein relate to a traction battery assembly, wherein the thermal barrier is in direct contact with the thermal exchange plate.

In some aspects, the techniques described herein relate to a traction battery assembly, wherein the thermal barrier includes a pocket that receives the thermal exchange plate such that the thermal barrier interfaces directly with a plurality of sides of the thermal exchange plate.

In some aspects, the techniques described herein relate to a traction battery assembly, wherein the enclosure structure is an enclosure mid-tray.

In some aspects, the techniques described herein relate to a traction battery assembly, wherein the battery array is an upper tier battery array.

In some aspects, the techniques described herein relate to a traction battery assembly, wherein the enclosure structure is an enclosure tray.

In some aspects, the techniques described herein relate to a traction battery assembly, wherein the battery array is a lower tier battery array.

In some aspects, the techniques described herein relate to a traction battery assembly, wherein the thermal barrier includes an intumescent.

In some aspects, the techniques described herein relate to a traction battery assembly, wherein the thermal barrier further including an aerogel 1 having an endothermic filler.

In some aspects, the techniques described herein relate to a traction battery assembly, further including a plurality of mechanical fasteners that fasten the thermal barrier to the thermal exchange plate.

In some aspects, the techniques described herein relate to a traction battery assembly, wherein the plurality of mechanical fasteners include a plurality of rivets.

In some aspects, the techniques described herein relate to a traction battery assembly, wherein the thermal barrier is adhesively secured to the thermal exchange plate.

In some aspects, the techniques described herein relate to a traction battery assembly, including: an upper tier thermal exchange plate at least one upper tier battery array disposed on the upper tier thermal exchange plate; a lower tier thermal exchange plate; at least one lower tier battery array, the lower tier battery array disposed on the lower tier thermal exchange plate; an enclosure mid-tray supporting the upper tier thermal exchange plate and the at least one upper tier battery array at a position that is vertically above the lower tier thermal exchange plate and the lower tier battery array; an enclosure tray supporting the lower tier thermal exchanger plate and the at least one lower tier battery array; and an upper tier thermal barrier sandwiched between the upper tier thermal exchange plate and the enclosure mid-tray.

In some aspects, the techniques described herein relate to a traction battery assembly, further including a lower tier thermal barrier sandwiched between the lower tier thermal exchange plate and the enclosure tray.

In some aspects, the techniques described herein relate to a traction battery assembly, wherein the upper tier thermal barrier and the lower tier thermal barrier each include an intumescent.

In some aspects, the techniques described herein relate to a method of shielding areas of a traction battery pack from thermal energy, including: positioning a thermal barrier between a thermal exchange plate and an enclosure structure, the thermal barrier configured to block transfer of thermal energy from the thermal exchange plate to the enclosure structure.

In some aspects, the techniques described herein relate to a method, wherein the thermal exchange plate manages thermal energy levels for an upper tier battery array of a traction battery.

In some aspects, the techniques described herein relate to a method, wherein the thermal barrier includes an intumescent.

In some aspects, the techniques described herein relate to a method, wherein the enclosure structure is an enclosure mid-tray.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a highly schematic view of an electrified vehicle having a traction battery pack.

FIG. 2 illustrates an expanded view of the traction battery pack of FIG. 1 according to an exemplary aspect of the present disclosure.

FIG. 3 illustrates a perspective view of the battery pack of FIG. 2.

FIG. 4 illustrates a section view taken at line 4-4 in FIG. 1.

### DETAILED DESCRIPTION

This disclosure details assemblies and methods of shielding areas of a battery pack from thermal energy, such as thermal energy resulting from a thermal runaway event.

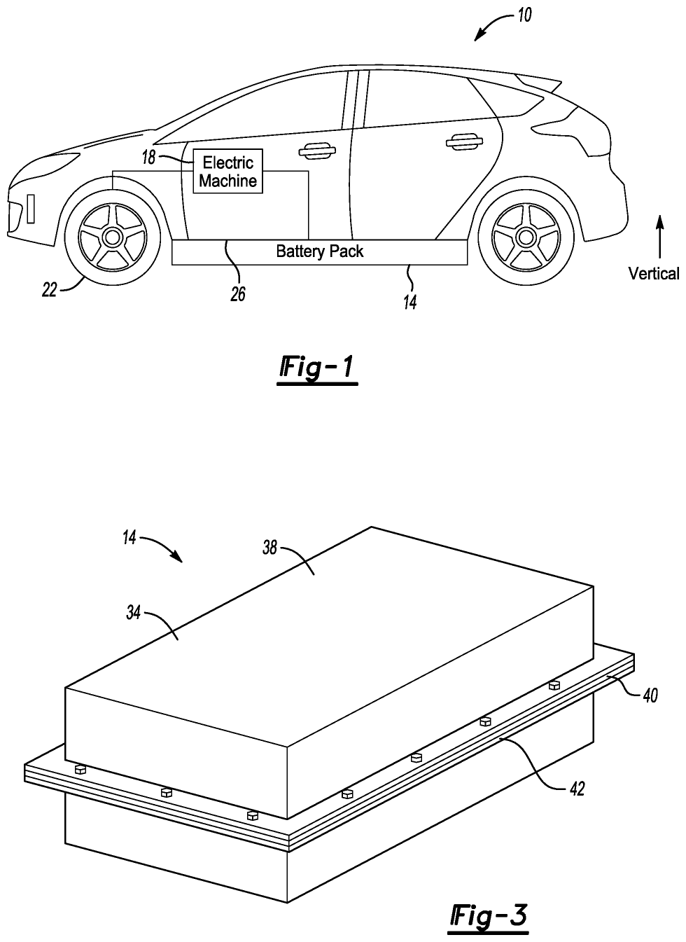

With reference to FIG. 1, an electrified vehicle 10 includes a traction battery pack 14, an electric machine 18, and wheels 22. The traction battery pack 14 powers an electric machine 18, which can convert electrical power to torque to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

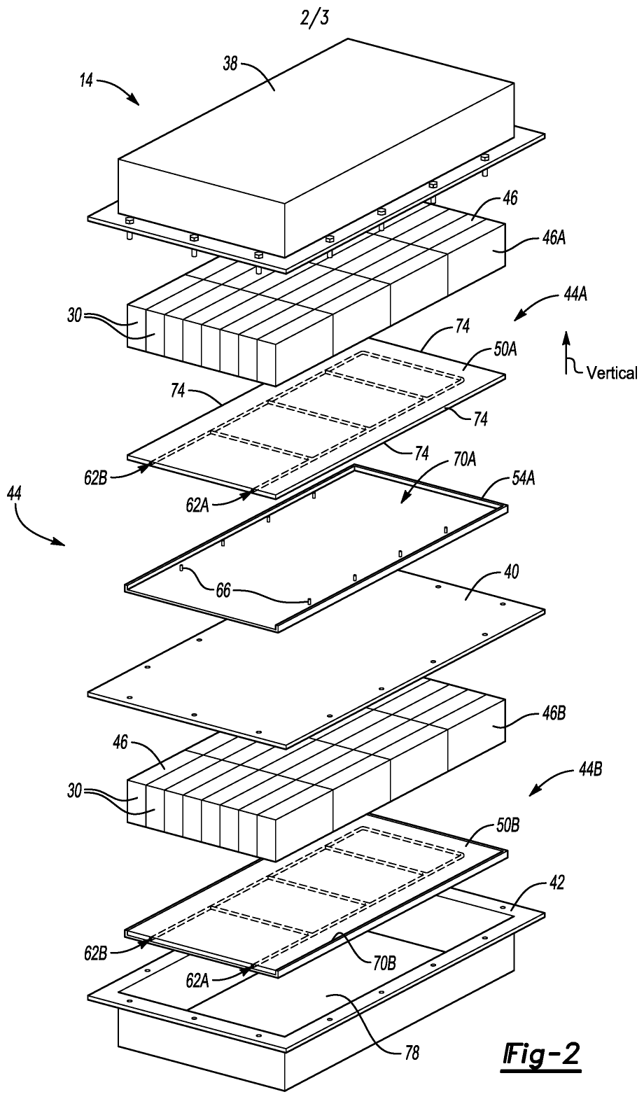

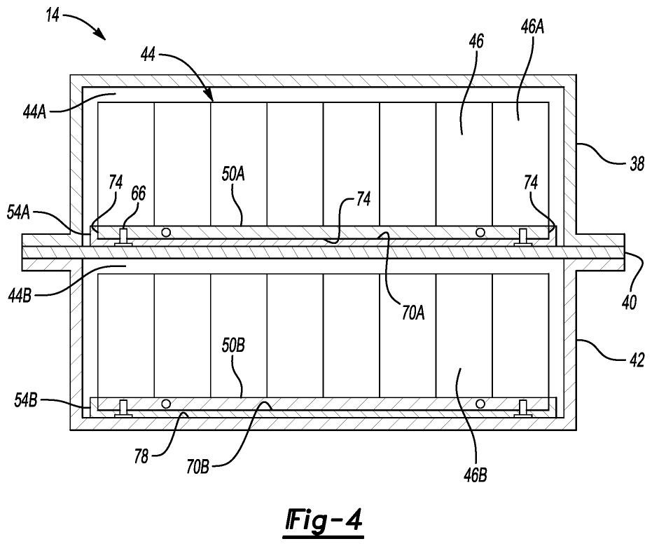

With reference now to FIGS. 2-4, the traction battery pack 14 includes a plurality of battery cells 30 held within an enclosure assembly 34. In the exemplary embodiment, the enclosure assembly 34 includes a plurality of enclosure structures. In this example, the enclosure structure include an enclosure cover 38, an enclosure mid-tray 40, and an enclosure tray 42. The enclosure cover 38 is secured to the enclosure tray 42 to provide an interior area 44. The enclosure mid-tray 40 partitions the interior area 44 into an upper area 44A and a lower area 44B.

When the traction battery pack 14 is assembled, the enclosure cover 38 can be secured to the enclosure tray 42 at an interface that extends circumferentially continuously about the interior area 44. Mechanical fasteners can be used to secure the enclosure cover 38 to the enclosure tray 42. The fasteners can additionally extend through the enclosure mid-tray 40 to secure the enclosure mid-tray 40.

The interior area 44 houses the plurality of battery cells 30. The plurality of battery cells (or simply, “cells”) 30 are for supplying electrical power to various components of the electrified vehicle 10. The battery cells 30 are stacked side-by-side relative to one another to construct a cell stack 46 or battery array. Although the various figures of this disclosure illustrates an example number of battery cells 30 and cells stacks 46, the traction battery pack 14 could include any number of cells 30 and cell stacks 46. In other words, this disclosure is not limited to the specific configuration of cells 30 shown in FIGS. 2-4.

In an embodiment, the battery cells 30 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

In this example, the traction battery pack 14 holds four upper tier cell stacks 46A within the upper area 44A, and four lower tier cell stacks 46B within the lower area 44B. In other examples, other numbers of upper tier cell stacks 46A and lower tier cell stacks 46B could be held within the upper area 44A and the lower area 44B, respectively.

The upper tier cell stacks 46A and upper area 44A are vertically above the lower tier cell stacks 46B and lower area 44B. Vertical, for purposes of this disclosure, is with reference to ground and a generally orientation of the electrified vehicle 10 during operation.

Within the upper area 44A, the traction battery pack 14 additionally holds an upper tier thermal exchange plate 50A and an upper tier thermal barrier 54A. Within the lower area 44B, the traction battery pack 14 additionally holds a lower tier thermal exchange plate 50B and a lower tier thermal barrier 54B.

The enclosure mid-tray 40 supports the upper tier cell stacks 46A, the upper tier thermal exchange plate 50A, and the upper tier thermal barrier 54A. The enclosure tray 42 supports the lower tier cell stacks 46B, the lower tier thermal exchange plate 50B, and the lower tier thermal barrier 54B.

The upper tier cell stacks 46A is disposed on the upper tier thermal exchange plate 50A. The upper tier thermal barrier 54A is sandwiched between the upper tier thermal exchange plate 50A and the enclosure mid-tray 40.

The lower tier cell stacks 46B are disposed on the lower tier thermal exchange plate 50B. The lower tier thermal barrier 54B is sandwiched between the lower tier thermal exchange plate 50B, and the enclosure tray 42.

In this example, a coolant is circulated through the upper tier thermal exchange plate 50A and the lower tier thermal exchange plate 50B through inlets 62A and outlets 62B. The coolant can take on thermal energy from the respective upper tier cell stacks 46A and lower tier cell stacks 46B so that the upper tier thermal exchange plate 50A can cool the upper tier cell stacks 46A and the lower tier thermal exchange plate 50B can cool the lower tier cell stacks 46B

The upper tier thermal barrier 54A directly contacts the upper tier thermal exchange plate 50A in this example. The upper tier thermal barrier 54A can be secured to the upper tier thermal exchange plate 50A with a plurality of mechanical fasteners 66. In this example, the mechanical fasteners 66 are rivets. In another example, the upper tier thermal barrier 54A is adhesively secured to the upper tier thermal exchange plate 50A.

The thermal energy levels in the upper tier thermal exchange plate 50A can increase when the upper tier thermal exchange plate 50A is cooling the upper tier cell stacks 46A. The upper tier thermal barrier 54A can help to block thermal energy from passing from upper area 44A through the enclosure mid-tray 40 into the lower area 44B, particularly when one or more of the upper tier cell stacks 46A are experiencing a thermal event. Should, for example, a thermal event occur in one of the one or more of the upper tier cell stacks 46A, the upper tier thermal barrier 54A can help to block thermal energy associated with the thermal event from moving to other battery arrays 30 in the lower area 44B, which could lead to a thermal runaway event.

The upper tier thermal barrier 54A can, in particular, block thermal energy from passing from the upper tier thermal exchange plate 50A through the enclosure mid-tray 40 to the lower area 44B.

The example upper tier thermal barrier 54A includes a pocket 70A that receives the upper tier thermal exchange plate 50A. Due to the pocket 70A, the upper tier thermal barrier 54A interfaces directly with a plurality of sides 74 of the upper tier thermal exchange plate 50A. Here a vertically bottom side and three outward facing sides. Covering more than one side can help to block thermal energy from transferring from the upper tier thermal barrier 54A through the enclosure mid-tray 40 to the lower area 44B than if the upper tier thermal barrier 54A just covered the vertically bottom side.

The upper tier thermal barrier 54A comprises an intumescent in this example. The intumescent can be an intumescent fill that is activated (i.e., swells) at temperatures from 180 to 200 degrees Celsius. In some examples, the upper tier thermal barrier 54A additionally includes an aerogel having an endothermic filler material. The endothermic filler material can be, for example, 1 to 8 percent-by-volume sodium silicate, or 0.5 to 5 percent-by-volume aluminum trihydride.

The lower tier thermal barrier 54B can also comprise an intumescent and, in some examples, an aerogel.

The lower tier thermal barrier 54B includes a pocket 70B that receives the lower tier thermal exchange plate 50B. The lower tier thermal barrier 54B can help to block thermal energy from the lower tier thermal exchange plate 50B from transferring to a floor 78 of the enclosure tray 42 and out of the enclosure assembly 34. The lower tier thermal barrier 54B can be secured to the lower tier thermal exchange plate 50B with mechanical fasteners, such as rivets, or adhesively secured.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery assembly, comprising:
a thermal exchange plate;
a battery array disposed on the thermal exchange plate;
an enclosure structure supporting the battery array and the thermal exchange plate; and
a thermal barrier sandwiched between the thermal exchange plate and the enclosure structure.

2. The traction battery assembly of claim 1, wherein the thermal barrier is in direct contact with the thermal exchange plate.

3. The traction battery assembly of claim 1, wherein the thermal barrier includes a pocket that receives the thermal exchange plate such that the thermal barrier interfaces directly with a plurality of sides of the thermal exchange plate.

4. The traction battery assembly of claim 1, wherein the enclosure structure is an enclosure mid-tray.

5. The traction battery assembly of claim 1, wherein the battery array is an upper tier battery array.

6. The traction battery assembly of claim 1, wherein the enclosure structure is an enclosure tray.

7. The traction battery assembly of claim 1, wherein the battery array is a lower tier battery array.

8. The traction battery assembly of claim 1, wherein the thermal barrier comprises an intumescent.

9. The traction battery assembly of claim 8, wherein the thermal barrier further comprising an aerogel having an endothermic filler.

10. The traction battery assembly of claim 1, further comprising a plurality of mechanical fasteners that fasten the thermal barrier to the thermal exchange plate.

11. The traction battery assembly of claim 10, wherein the plurality of mechanical fasteners comprise a plurality of rivets.

12. The traction battery assembly of claim 1, wherein the thermal barrier is adhesively secured to the thermal exchange plate.

13. A traction battery assembly, comprising:
an upper tier thermal exchange plate
at least one upper tier battery array disposed on the upper tier thermal exchange plate;
a lower tier thermal exchange plate;
at least one lower tier battery array, the lower tier battery array disposed on the lower tier thermal exchange plate;
an enclosure mid-tray supporting the upper tier thermal exchange plate and the at least one upper tier battery array at a position that is vertically above the lower tier thermal exchange plate and the lower tier battery array;
an enclosure tray supporting the lower tier thermal exchanger plate and the at least one lower tier battery array; and
an upper tier thermal barrier sandwiched between the upper tier thermal exchange plate and the enclosure mid-tray.

14. The traction battery assembly of claim 13, further comprising a lower tier thermal barrier sandwiched between the lower tier thermal exchange plate and the enclosure tray.

15. The traction battery assembly of claim 14, wherein the upper tier thermal barrier and the lower tier thermal barrier each comprise an intumescent.

16. A method of shielding areas of a traction battery pack from thermal energy, comprising:
positioning a thermal barrier between a thermal exchange plate and an enclosure structure, the thermal barrier configured to block transfer of thermal energy from the thermal exchange plate to the enclosure structure.

17. The method of claim 16, wherein the thermal exchange plate manages thermal energy levels for an upper tier battery array of a traction battery.

18. The method of claim 16, wherein the thermal barrier comprises an intumescent.

19. The method of claim 16, wherein the enclosure structure is an enclosure mid-tray.
